(19) United States
(12) Patent Application Publication
(10) Pub. No.: US 2016/0373908 A1
(43) Pub. Date: Dec. 22, 2016

(54) DELIVERY DEVICE, COMMUNICATION TERMINAL, DELIVERY METHOD, RECEIVING METHOD, AND NON-TRANSITORY COMPUTER-READABLE MEDIUM STORING PROGRAM

(71) Applicant: NEC CORPORATION, Tokyo (JP)

(72) Inventors: Takanori IWAI, Tokyo (JP); Masayoshi SHIMIZU, Tokyo (JP); Takaaki SUZUKI, Tokyo (JP)

(73) Assignee: NEC CORPORATION, Tokyo (JP)

(21) Appl. No.: 14/901,781

(22) PCT Filed: Jul. 1, 2014
(86) PCT No.: PCT/JP2014/003490

§ 371 Date: Dec. 29, 2015

(30) Foreign Application Priority Data
Jul. 3, 2013 (JP) 2013-140157

(51) Int. Cl. H04W 4/22; H04W 72/08; H04W 4/06; H04L 29/08; H04W 4/02

(52) U.S. Cl. CPC H04W 4/22; H04L 67/26; H04W 4/025; H04W 4/06; H04W 72/085; H04M 3/487

(57) ABSTRACT

A delivery device includes an information management unit that manages delivery information which is to be delivered to a plurality of communication terminals located in a peripheral area including a place where an event has occurred and which is determined depending on details of the event and a distance from the place where the event has occurred, a message analysis unit that, when an event notification message indicating occurrence of an event is sent, analyzes the place where the event has occurred and details of the event by using the event notification message, and a delivery unit that extracts delivery information managed in the information management unit based on an analysis result in the message analysis unit and delivers the extracted delivery information to the plurality of communication terminals located in the peripheral area.

### TECHNICAL FIELD

The present invention relates to a delivery device and, for example, to a delivery device that delivers information using broadcast delivery or unicast communication.

### BACKGROUND ART

Generally, Cell Broadcast Service (CBS) is used to rapidly deliver disaster information or the like through a communication network. The CBS is a service that delivers information sent from an information delivery source device on the cell-by-cell basis managed by a base station. Specifically, with use of the CBS, it is possible to send the same information to all of communication terminals located in a cell. All of the communication terminals located in the cell can thereby receive the same information through the base station. The network configuration of the CBS, the operations of devices that form the CBS and the like are disclosed in Non Patent Literature 1, for example.

### CITATION LIST

### Non Patent Literature

NPL1: 3GPP TS 23.041 V12.2.0 (2013-06) 3rd Generation Partnership Project; Technical Specification Group Core Network and Terminals; Technical realization of Cell Broadcast Service (CBS) (Release 12)

### SUMMARY OF INVENTION

### Technical Problem

In the case of using the CBS, all base stations deliver the same information to communication terminals. Therefore, each of communication terminals that are located in a CBS message delivery area which includes a plurality of cells receives the same information. In some cases, however, information that is necessary for each of communication terminals is different depending on areas, or cells, for example, where the terminals are located. In the case of using the CBS, the same information is delivered to all of the terminals in the delivery area. Thus, when necessary information is different depending on cells where communication terminals are located, each of the communication terminals cannot receive necessary information.

An exemplary object of the present invention is to provide a delivery device, a communication terminal, a delivery method, a receiving method, and a program capable of delivering different information depending on areas.

### Solution to Problem

A delivery device according to a first exemplary aspect of the present invention includes an information management unit that manages delivery information to be delivered to a plurality of communication terminals located in a peripheral area including a place where an event has occurred, the delivery information being determined depending on details of the event and a distance from the place where the event has occurred, a message analysis unit that, when an event notification message indicating occurrence of an event is sent, analyzes the place where the event has occurred and details of the event by using the event notification message, and a delivery unit that extracts delivery information managed in the information management means based on an analysis result in the message analysis means and delivers the extracted delivery information to the plurality of communication terminals located in the peripheral area.

A communication terminal according to a second exemplary aspect of the present invention includes a receiving unit that receives delivery information delivered from a delivery device that delivers delivery information to be delivered to a plurality of communication terminals located in a peripheral area including a place where an event has occurred, the delivery information being determined depending on details of the event and a distance from the place where the event has occurred, a distance measurement unit that measures a distance between a position of the communication terminal and the place where the event has occurred, and an information extraction unit that extracts information to be received from the delivery information based on a measurement result in the distance measurement unit.

A delivery method according to a third exemplary aspect of the present invention includes receiving an event notification message indicating occurrence of an event, analyzing a place where the event has occurred and details of the event by using the event notification message, extracting delivery information from

information management means for managing delivery information to be delivered to a plurality of communication terminals located in a peripheral area including a place where an event has occurred, the delivery information being determined depending on details of the event and a distance from the place where the event has occurred based on a result of the analysis, and delivering the extracted delivery information to the plurality of communication terminals located in the peripheral area.

A receiving method according to a fourth exemplary aspect of the present invention includes receiving delivery information delivered from a delivery device that delivers delivery information to be delivered to a plurality of communication terminals located in a peripheral area including a place where an event has occurred, the delivery information being determined depending on details of the event and a distance from the place where the event has occurred, measuring a distance between a position of a communication terminal and the place where the event has occurred, and extracting information to be received from the delivery information based on a result of the measurement.

A program according to a fifth exemplary aspect of the present invention causes a computer to execute a step of receiving an event notification message indicating occurrence of an event, a step of analyzing a place where the event has occurred and details of the event by using the event notification message, a step of extracting delivery information from information management means for managing delivery information to be delivered to a plurality of communication terminals located in a peripheral area including a place where an event has occurred, the delivery information being determined depending on details of the event and a distance from the place where the event has occurred based on a result of the analysis, and a step of delivering the extracted delivery information to the plurality of communication terminals located in the peripheral area.

### Advantageous Effects of Invention

According to the exemplary aspects of the present invention, it is possible to provide a delivery device, a communication terminal, a delivery method, a receiving method, and a program capable of delivering different information depending on areas.

### BRIEF DESCRIPTION OF DRAWINGS

FIG. 1 is a block diagram of a delivery device according to a first exemplary embodiment;

FIG. 2 is a block diagram of an information delivery system according to a second exemplary embodiment;

FIG. 3 is a diagram showing a flow of a delivery information sending process according to the second exemplary embodiment;

FIG. 4 is a diagram showing an area management table according to the second exemplary embodiment;

FIG. 5 is a block diagram of a delivery device according to the second exemplary embodiment;

FIG. 6 is a diagram showing a delivery information management table according to the second exemplary embodiment;

FIG. 7 is a block diagram of an information delivery system according to a third exemplary embodiment;

FIG. 8 is a block diagram of an information delivery system according to a fourth exemplary embodiment;

FIG. 9 is a diagram showing a flow of a delivery information sending process according to the fourth exemplary embodiment;

FIG. 10 is a block diagram of UE according to a fifth exemplary embodiment;

FIG. 11 is a diagram showing a flow of a receiving process according to the fifth exemplary embodiment;

FIG. 12 is a diagram illustrating determination conditions in UE according to the fifth exemplary embodiment;

FIG. 13 is a block diagram of eNB according to a sixth exemplary embodiment;

FIG. 14 is a diagram showing a flow of a delivery information sending process according to the sixth exemplary embodiment;

FIG. 15 is a diagram showing parameters set to a Write-Replace Warning Request message according to the sixth exemplary embodiment;

FIG. 16 is a diagram showing parameters set to a Cell Broadcast delivery message according to the sixth exemplary embodiment;

FIG. 17 is a diagram showing a flow of a delivery information sending process according to the sixth exemplary embodiment;

FIG. 18 is a diagram showing parameters set to a Write-Replace message according to the sixth exemplary embodiment;

FIG. 19 is a block diagram of an information delivery system according to a seventh exemplary embodiment;

FIG. 20 is a block diagram of an information delivery system according to an eighth exemplary embodiment;

FIG. 21 is a diagram showing a network in the case where CBS is used according to the eighth exemplary embodiment; and

FIG. 22 is a diagram showing a network in the case where MBMS is used according to the eighth exemplary embodiment.

### DESCRIPTION OF EMBODIMENTS

### First Exemplary Embodiment

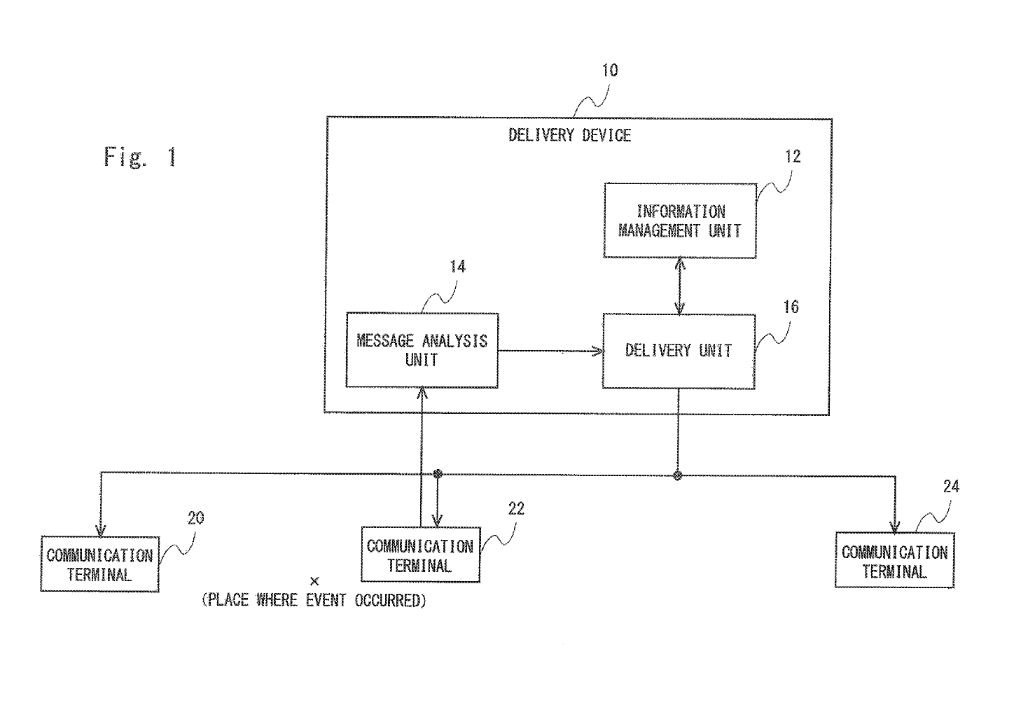

Exemplary embodiments of the present invention are described hereinafter with reference to the drawings. First, a configuration example of a delivery device 10 according to a first exemplary embodiment of the present invention is described with reference to FIG. 1. The delivery device 10 includes an information management unit 12, a message analysis unit 14, and a delivery unit 16.

The information management unit 12 manages delivery information which is to be delivered to a plurality of communication terminals located in a peripheral area including a place where an event has occurred and which is determined depending on the details of the event and the distance from the place where the event has occurred.

The place where an event has occurred may be, for example, a place where a traffic accident has occurred, a place where a crime has occurred or the like. The peripheral area may be, for example, an area that is defined as being an area in which the place where an event that has occurred is in the center thereof, such as a range of several kilometers or several meters from the place where an event has occurred. Further, the peripheral area may have a concentric shape centering on the place where an event has occurred. Alternatively, the peripheral area may have a polygonal shape such as a triangle or a square, an elliptical shape or the like. Furthermore, the peripheral area may have, for example, a shape that is associated with geographic information, such as along a road or from a block A to a block B.

The details of an event may be, for example, information indicating whether the event that has occurred is a traffic accident or a crime. The details of an event, however, are not limited thereto, and the details of an event may be information indicating various events different from the traffic accident and the crime. The distance from the place where an event has occurred is, for example, the distance between a communication terminal that receives delivery information and the place where an event has occurred.

The message analysis unit 14 receives an event notification message from a communication terminal 22 that has detected the occurrence of an event and then analyzes the position of the communication terminal 22 that has sent the event notification message and the details of the event that is detected by the communication terminal 22 by using the event notification message.

The communication terminal 22 may be, for example, a communication terminal which a person who saw an event has. In this case, the person who saw an event may input the details of the event to the communication terminal and send information about the details of the event to the message analysis unit 14 via a wireless network or the like.

Alternatively, the communication terminal 22 may be, for example, a terminal mounted on a vehicle. A vehicle that is involved in a traffic accident may detect the traffic accident and autonomously send the detected information to the message analysis unit 14. For example, a sensor that detects an impact may be mounted on a vehicle, and it may be determined that a traffic accident has occurred when the sensor detects an impact. In this case, the vehicle that is involved in the traffic accident may send information indicating the occurrence of the traffic accident to the message analysis unit 14 through a communication terminal or a communication module mounted on the vehicle.

The communication terminal 22 sends the event notification message in which information indicating the current position and the details of the event is set to the message analysis unit 14. The information indicating the current position may be, for example, GPS positioning information in the case where the communication terminal 22 has GPS function. Alternatively, in the case where the communication terminal is located in a cell area formed by a base station and wirelessly communicates with the base station, the information indicating the current position may be information about the cell where the communication terminal is located. The information about the cell contains, for example, a cell ID or the like. The current position of the communication terminal 22 may be regarded as being the place where the event has occurred.

The message analysis unit 14 analyzes the event notification message and specifies the position of the communication terminal 22 and the details of the event.

The delivery unit 16 extracts delivery information managed in the information management unit 12 according to an analysis result in the message analysis unit 14 and delivers the extracted delivery information to a plurality of communication terminals that are located in the peripheral area of the place where the event has occurred.

As described above, the delivery device 10 according to the first exemplary embodiment of the present invention receives the event notification message sent from a communication terminal and can specify the details of an event that has occurred and the place where the event has occurred. Further, the delivery device 10 can deliver different information to communication terminals located in different places. The delivery device 10 can thereby deliver information necessary for each communication terminal to the communication terminals depending on the details of the event and the distance from the place where the event has occurred.

Note that, although the case where the communication terminal 22 that has detected an event sends the event notification message to the message analysis unit 14 is illustrated in FIG. 1, the device that sends the event notification message is not limited to the communication terminal 22. For example, the message analysis unit 14 may receive the event notification message that is sent from an external server device or the like that has detected an event.

### Second Exemplary Embodiment

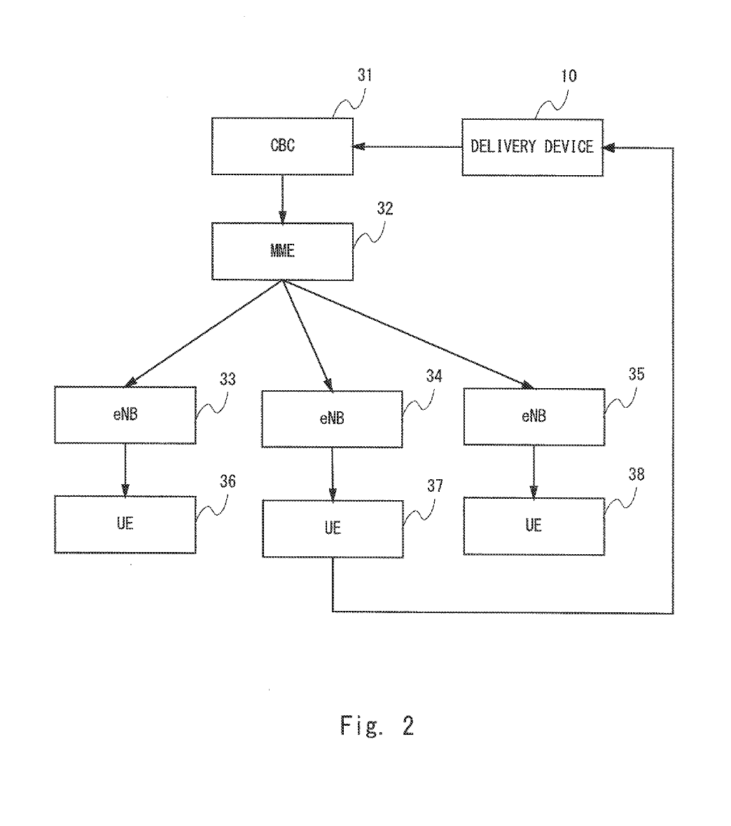

A configuration example of an information delivery system according to a second exemplary embodiment of the present invention is described hereinafter with reference to FIG. 2. The information delivery system in FIG. 2 is a network specified by the 3GPP and is formed by a network that provides the CBS. Further, although a configuration using the network specified by the 3GPP for the information delivery system is illustrated in FIG. 2, it is not limited to the network specified by the 3GPP, and another mobile communication network such as a PHS communication network may be used. Alternatively, instead of the mobile communication network, a fixed communication network that is used for landline phone communication, a network that is used for W-LAN communication or the like may be used for the information delivery system. A variety of networks may also be used in other exemplary embodiments.

The information delivery system of FIG. 2 includes a delivery device 10, a Cell Broadcast Center (CBC) 31, a Mobile Management Element (MME) 32, evolved Node B (eNB) 33 to 35 and User Equipment (UE) 36 to 38. The delivery device 10 is the same as the delivery device 10 in FIG. 1 and thus is indicated by the same reference number as that in FIG. 1.

The UE 36 to 38 correspond to the communication terminals 20 to 24 in FIG. 1. The CBC 31, the MME 32 and the eNB 33 to 35 form a mobile communication network. The delivery device 10 is, for example, a device that is placed in a network different from the mobile communication network. For example, the delivery device 10 may be an application server that provides an application service to UE or the like that performs communication via a mobile communication network or may be a device that forms a service platform that provides an application service. The delivery device 10 is a device that is managed by a business operator different from the business operator that manages the mobile communication network. Each of the devices shown in FIG. 2 is described hereinbelow.

The eNB 33 to 35 are base stations that comply with Long Term Evolution (LTE) as a wireless system. Although the configuration example in which the eNB 33 to 35 are used as base stations is illustrated in FIG. 2, Node B (NB) or the like that complies with the 2G or 3G system may be used. The eNB 33 to 35 send data sent to them from a higher-level device in the mobile communication network to the UE 36 to 38, and send data sent to them from the UE 36 to 38 to the higher-level device. The higher-level device is the MME 32, the CBC 31 or the like, for example. The higher-level device may be referred to as a relay device.

When the eNB 33 to 35 send data to the UE 36 to 38, they perform cell broadcast communication that sends data to all of the UE located in the cells formed by the eNB 33 to 35. In the cell broadcast communication, the MME 32 instructs the eNB to deliver data on a cell-by-cell basis, and then the eNB delivers the data to all of the UE located in the cell. The cell to which data is to be delivered is determined in the CBC 31.

The MME 32 is connected with the eNB 33 to 35. The MME 32 manages the movement of the UE 36 to 38. For example, when an incoming call message to any of the UE 36 to 38 is sent, the MME 32 specifies a location registration area where the UE is located and performs an attempt to call the UE. Further, the MME 32 sends and receives a control message about the UE 36 to 38.

The CBC 31 is connected with the MME 32 and the delivery device 10. When the CBC 31 receives a delivery notification message that contains a delivery area to which delivery information is to be delivered and the delivery information corresponding to the delivery area from the delivery device 10, the CBC 31 determines the delivery area on a cell-by-cell basis and further creates a message (CBS message) that contains the delivery area and the delivery information on the cell-by-cell basis. The CBC 31 sends the created CBS message to the eNB through the MME 32. The delivery area determined by the CBC 31 is, for example, information indicating the cell to which the delivery information is to be delivered. The CBC 31 converts the area to which the delivery information is to be delivered which is indicated by the delivery device 10 into information that specifies the cell to which the delivery information is to be delivered.

The delivery device 10 is connected with the CBC 31. The delivery device 10 receives an event notification message that notifies it about the occurrence of an event from the UE. The delivery device 10 may receive the event notification message via a mobile communication network or may receive the event notification message via a network different from a mobile communication network, such as the Internet, which is a network provided by an internet service provider or the like, for example. Although FIG. 2 shows the case where the delivery device 10 receives the event notification message that is sent from the UE 37, the delivery device 10 may receive the event notification message that is sent from a plurality of UE. Further, the delivery device 10 sends a delivery notification message that is determined based on the event notification message to the CBC 31. The delivery device 10 also sends, together with the delivery information, information about the area to which the delivery information is to be delivered to the CBC 31.

The UE 36 to 38 are terminals that receive the CBS message delivered from the CBC 31. Further, when the UE 36 to 38 detect an event, they send the event notification message to the delivery device 10 in order to notify the delivery device 10 of the detected event.

When the UE 36 to 38 output the received CBS message to a display unit (not shown) or the like, they may let a user who operates the UE know the urgency of the CBS message by a beep sound.

Further, the delivery device 10 may perform control to change the behavior of the UE depending on the delivery area. For example, the delivery device 10 may send a message instructing to display the CBS message by a pop-up and sound a beep for the UE located in an area at a short distance from the area where an event has occurred. Further, the delivery device 10 may send a message instructing to display the CBS message by a pop-up for the UE located in an area at an intermediate distance from the area where an event has occurred. Furthermore, the delivery device 10 may send a message instructing to store the CBS message into an email inbox folder, for example, without displaying the CBS message by a pop-up for the UE located in an area at a long distance from the area where an event has occurred.

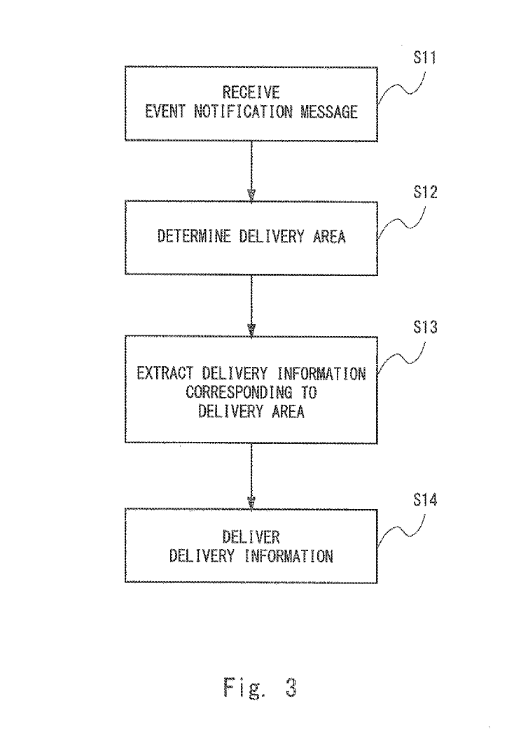

A flow of a delivery information sending process of the delivery device 10 according to the second exemplary embodiment of the present invention is described hereinafter with reference to FIG. 3. First, the message analysis unit 14 receives the event notification message that is sent from any of the UE 36 to 38 (S11). Alternatively, the message analysis unit 14 may receive the event notification message that is sent from a plurality of UE.

Next, the message analysis unit 14 specifies the position of the UE that has sent the event notification message by using the received event notification message. The message analysis unit 14 further regards the specified position of the UE as the place where an event has occurred and determines the delivery area by using the information management unit 12 (S12).

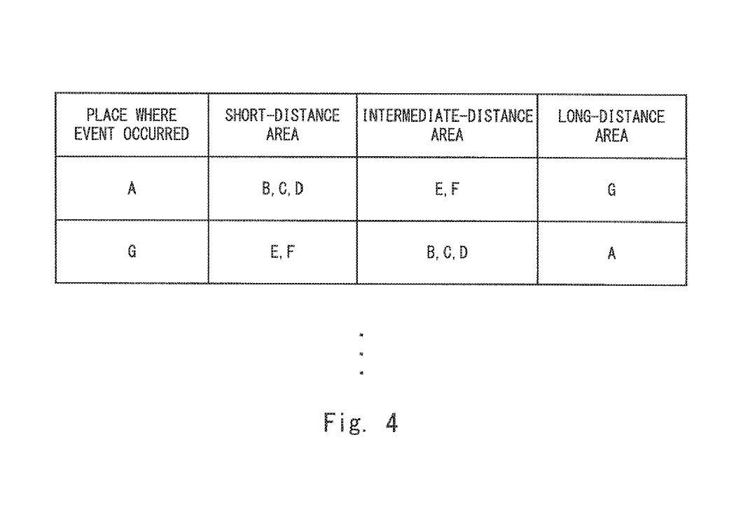

An area management table in which the place where an event has occurred and the delivery area are associated is described hereinafter with reference to FIG. 4. The information management unit 12 has the area management table. The area management table manages the place where an event has occurred in association with a short-distance area, an intermediate-distance area and a long-distance area that are defined according to the distance from the place where the event has occurred. For example, areas A to G are defined as the areas where the UE is located. If it is assumed that the place where an event has occurred is the area A, the short-distance area is the areas B, C and D, the intermediate-distance area is the areas E and F, and the long-distance area is the area G. If it is assumed that the place where an event has occurred is the area G, the short-distance area is the areas E and F, the intermediate-distance area is the areas B, C and D, and the long-distance area is the area A. The delivery device 10 delivers information to the UE located in each of the areas that is, the places where an event has occurred, the short-distance area, the intermediate-distance area and the long-distance area.

In the area management table of FIG. 4, the delivery areas corresponding to the place where an event has occurred may be defined in advance or may be defined according to a delivery policy each time there is a notification of the occurrence of an event. For example, the case where the delivery policy defines the range of A kilometers in radius from the place where an event has occurred as the short-distance area, the range of B kilometers in radius as the intermediate-distance area, and the range of C kilometers in radius as the long-distance area is described. In this case, when the place where an event has occurred is specified by the message analysis unit 14, the information management unit 12 determines the short-distance area, the intermediate-distance area and the long-distance area on the basis of the place where the event has occurred.

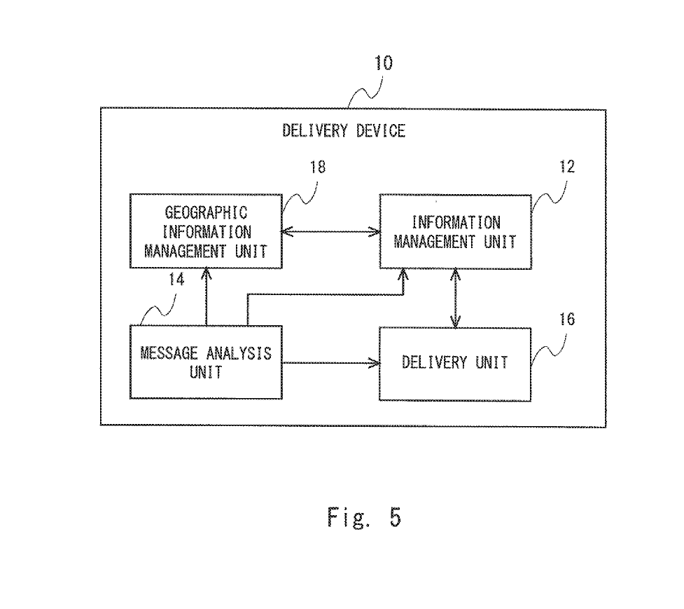

The areas A to G may be the areas with which the position of an expressway, address information and the like are associated. For example, as shown in FIG. 5, the delivery device 10 may include a geographic information management unit 18 that manages geographic information such as the position of an expressway, address information and the like. For example, the information management unit 12 may acquire the address information corresponding to the areas A to G from the geographic information management unit 18. Further, when the place where an event has occurred is estimated by the message analysis unit 14, the geographic information management unit 18 may specify the address information corresponding to the place where the event has occurred. Further, when it is specified that the place where an event has occurred is on an expressway, the geographic information management unit 18 may output instruction information to the information management unit 12 so that the delivery area is an area on the expressway.

Referring back to FIG. 3, the delivery unit 16 extracts the delivery information corresponding to the delivery area from the information management unit 12 (S13). To be specific, the delivery unit 16 extracts the delivery information corresponding to the delivery area from the information management unit 12 by using the delivery area determined in Step S12 and the details of the event which the event notification message gave a notification about.

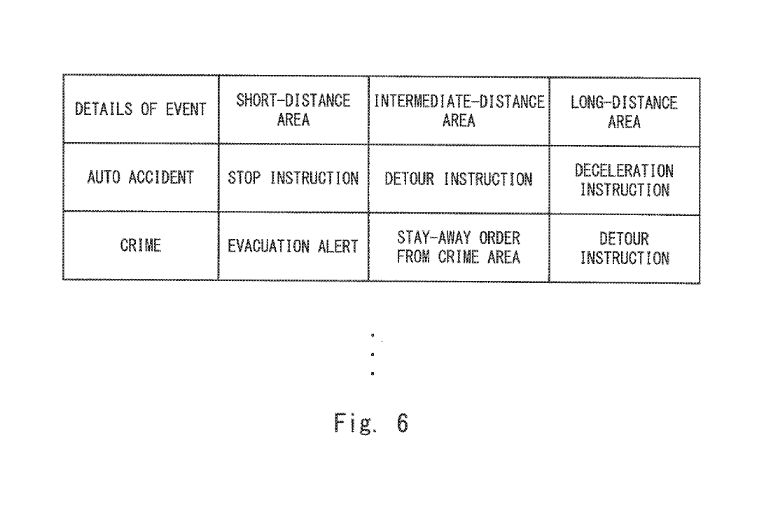

A delivery information management table in which the delivery area and the delivery information are associated is described hereinafter with reference to FIG. 6. The information management unit 12 has the delivery information management table. The delivery information management table manages the information to be delivered to each of the short-distance area, the intermediate-distance area and the long-distance area. For example, in the case where the event which has occurred is an auto accident, information indicating a stop instruction is delivered to the UE located in the short-distance area. The UE to which the information is to be delivered may be, for example, a communication terminal that is mounted on a vehicle, a car navigation system on a vehicle, or a communication terminal held by a user riding in a vehicle. In the case where the event which has occurred is an auto accident, information indicating a detour instruction is delivered to the UE located in the intermediate-distance area, and information indicating a deceleration instruction is delivered to the UE located in the long-distance area.

On the other hand, in the case where the event which has occurred is a crime, information indicating an evacuation alert is delivered to the UE located in the short-distance area, information indicating a stay-away from the crime area order is delivered to the UE located in the intermediate-distance area, and information indicating a detour instruction is delivered to the UE located in the long-distance area. Although examples of the information to be delivered when an auto accident and a crime occurs are shown in the delivery information management table of FIG. 5, the delivery information when another event occurs may be managed therein.

Referring back to FIG. 3, the delivery unit 16 sends the information about the delivery area and the delivery information associated with the delivery area to the CBC 31 (S14). The CBC 31 specifies the cell that is associated with the delivery area which the delivery unit 16 has given a notification about, and sends, to the specified cell, the CBS message in which the delivery information which the delivery unit 16 has given a notification thereof is set. The CBC 31 sends the CBS message to each of the cell corresponding to the short-distance area, the cell corresponding to the intermediate-distance area and the cell corresponding to the long-distance area.

As described above, with use of the information delivery system according to the second exemplary embodiment of the present invention, it is possible to deliver different delivery information to the UE depending on the distance from the place where an event has occurred. Specifically, it is possible to deliver different delivery information to the short-distance area, the intermediate-distance area and the long-distance area defined depending on the distance from the place where an event has occurred by using the CBS.

Further, the delivery device 10 may set the priority of delivery and the period of delivery depending on the delivery area. For example, the delivery device 10 may deliver information to the UE located in the short-distance area in accordance with a priority order. For example, the delivery device 10 may first deliver information to the UE located in the short-distance area, then deliver information to the UE located in the intermediate-distance area, and then finally deliver information to the UE located in the long-distance area.

Further, for example, the delivery device 10 may deliver information to the UE located in the short-distance area most frequently, may deliver information to the UE located in the intermediate-distance area second most frequently, and may deliver information to the UE located in the long-distance area least frequently.

By setting the priority of delivery and the period of delivery depending on the delivery area, it is possible to more quickly and more reliably deliver information to the UE located at a position closer to the place where an event has occurred.

### Third Exemplary Embodiment

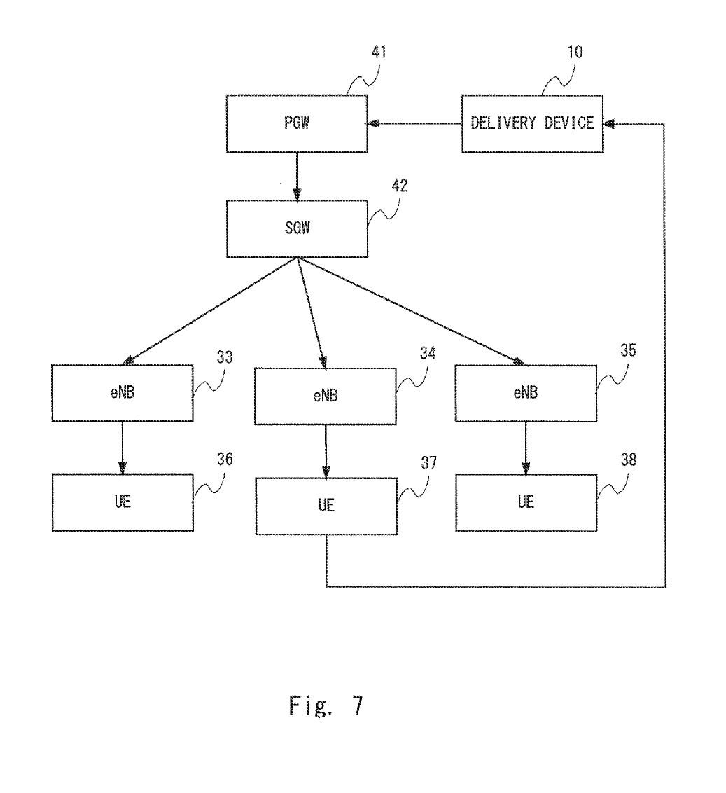

A configuration example of an information delivery system according to a third exemplary embodiment of the present invention is described hereinafter with reference to FIG. 7. The information delivery system of FIG. 7 is a network specified by the 3GPP. The information delivery system of FIG. 6 includes a delivery device 10, Packet Data Network Gateway (PGW) 41, Serving Gateway (SGW) 42, eNB 33 to 35 and UE 36 to 38. The delivery device 10, the eNB 33 to 35 and the UE 36 to 38 are the same as those of FIG. 2 and thus detailed descriptions thereof are omitted.

The PGW 41 is a gateway device that communicates with a device placed in an external network which is different from a mobile communication network formed by the PGW 41, the SGW 42 and the eNB 33 to 35. The PGW 41 sends the data sent from the device placed in the external network to the UE 36 to 38 through the SGW 42 and the eNB 33 to 35. The SGW 42 relays the data sent and received between the PGW 41 and the eNB 33 to 35.

The delivery device 10 is connected with the PGW 41. The delivery device 10 receives an event notification message that notifies about the occurrence of an event from the UE. Further, the delivery device 10 sends delivery information that is determined based on the event notification message to the PGW 41. The delivery device 10 also sends, together with the delivery information, information about the area to which the delivery information is to be delivered to the PGW 41.

The PGW 41 sends the delivery information by unicast communication to the UE located in the delivery area that the delivery device 10 gives a notification about. Specifically, the PGW 41 sets the destination of the delivery information as being the UE and sends the delivery information to the UE. The PGW 41 may specify the UE located in the delivery destination area by using HSS (not shown). Further, the HSS may manage the delivery destination area which the delivery device 10 has given a notification about and the area used for managing the position of the UE in the mobile communication network in association with each other. In this manner, the HSS can specify the UE located in the delivery destination area which the delivery device 10 has given a notification about.

The PGW 41 sends the delivery information that is determined for each delivery destination area which the delivery device 10 has given a notification about to the UE.

In the case of using unicast communication, the delivery information may be changed for each delivery destination area, and the delivery information may be changed for each UE. For example, the delivery information may be changed depending on the terminal type or the like of the UE. In the case where the UE to which the information is to be delivered is a smartphone, the delivery information may contain a larger number of letters compared with the case where the UE to which the information is a cellular phone having a smaller display unit than the smartphone.

Alternatively, the delivery information may be changed depending on the age of a user who has the UE. For example, when a user who has the UE to which the information is to be delivered is an elementary student, the details of the delivery information may be made simpler and shorter compared with the case where a user who has the UE is an adult.

The terminal type of the UE, the age information and the like may be set in subscriber information stored in the HSS. Further, the delivery device 10 may instruct the PGW 41 to change the delivery information depending on the terminal type of the UE, the age information and the like.

As described above, with use of the information delivery system according to the third exemplary embodiment of the present invention, it is possible to send the delivery information which the delivery device 10 has given a notification about in the mobile communication network by using unicast communication in which the destination is set to the UE. By using unicast communication, it is possible to change the delivery information depending on the UE to which the information is to be delivered compared with the case in which the CBS is used.

### Fourth Exemplary Embodiment

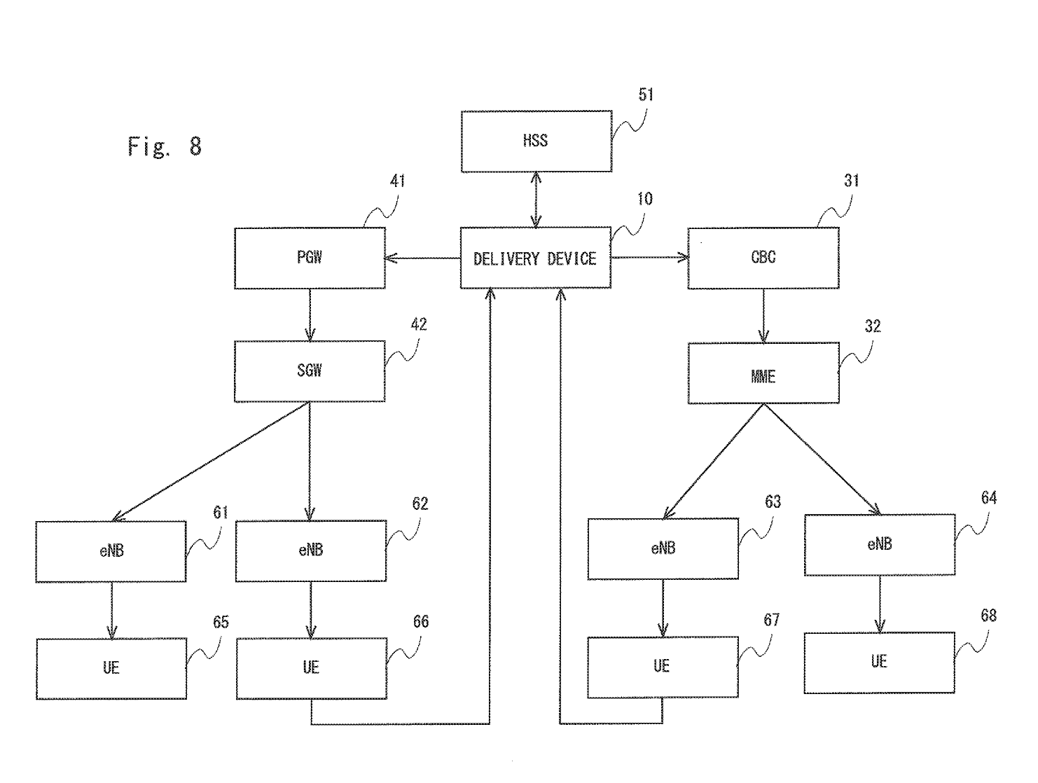

A configuration example of an information delivery system according to a fourth exemplary embodiment of the present invention is described hereinafter with reference to FIG. 8. The information delivery system of FIG. 8 includes a delivery device 10, CBC 31, MME 32, PGW 41, SGW 42, eNB 61 to 64, UE 65 to 68 and HSS 51.

The information delivery system of FIG. 8 has a configuration that combines the configuration of FIG. 2 showing the configuration example of the information delivery system using the CBS and the configuration of FIG. 7 showing the configuration example of the information delivery system that performs unicast communication. CBC 31, MME 32, eNB 63 to 64 and UE 67 to 68 are substantially the same as those of FIG. 2, though the reference numbers of eNB and UE are different. Further, PGW 41, SGW 42, eNB 61 to 62 and UE 65 to 66 are substantially the same as those of FIG. 7, though the reference numbers of eNB and UE are different.

The delivery device 10 is connected with the CBC 31, the PGW 41 and the HSS 51. When delivering information, the delivery device 10 selects at least one of the CBC 31 and the PGW 41 and then delivers the information to the UE through the selected device. The delivery device 10 may use information stored in the HSS 51 when selecting at least one of the CBC 31 and the PGW 41.

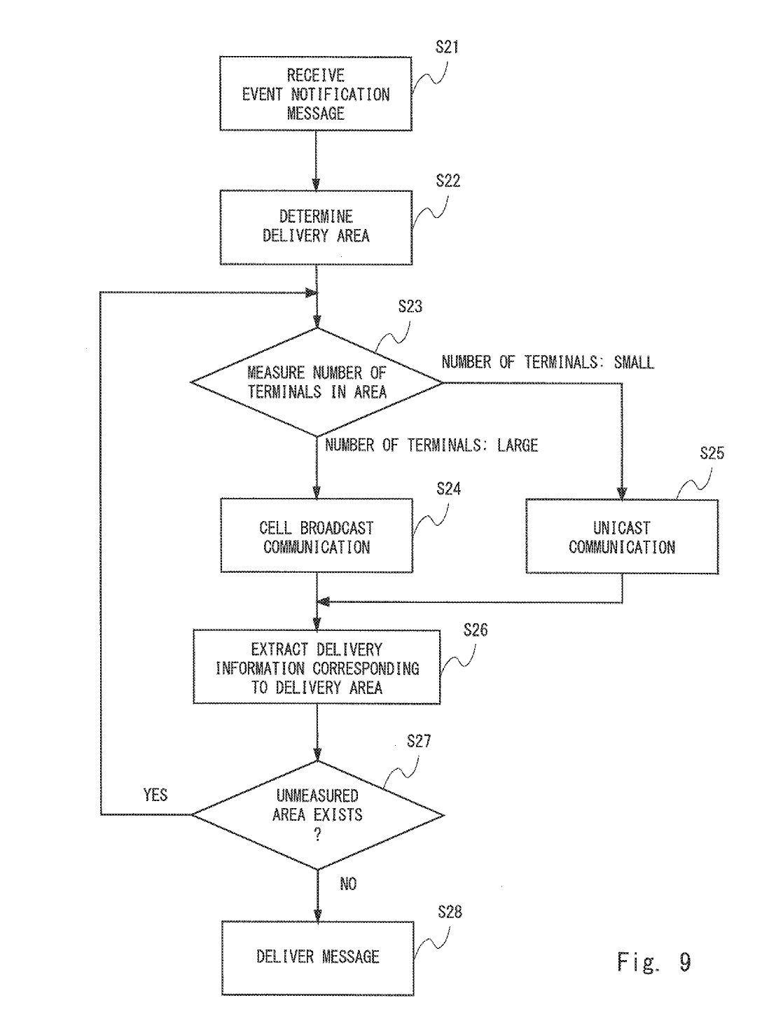

A flow of a message delivery process according to the fourth exemplary embodiment of the present invention is described with reference to FIG. 9. One feature of the message delivery process of FIG. 9 is that the delivery device 10 determines whether to select cell broadcast communication or unicast communication.

First, the message analysis unit 14 receives the event notification message that is sent from any of the UE 65 to 68 (S21). Alternatively, the message analysis unit 14 may receive the event notification message that is sent from a plurality of UE.

Next, the message analysis unit 14 specifies the position of the UE that has sent the event notification message by using the received event notification message. The message analysis unit 14 further regards the specified position of the UE as the place where an event has occurred and determines the delivery area by using the information management unit 12 (S22). The message analysis unit 14 set, for example, the short-distance area, the intermediate-distance area and the long-distance area shown in FIG. 4 as the delivery area.

Then, the message analysis unit 14 counts the number of UE in each of the short-distance area, the intermediate-distance area and the long-distance area determined (S23). The message analysis unit 14 may count the number of UE in the short-distance area first. For example, the message analysis unit 14 counts the number of UE in each area by using the position information of each UE that is stored in the HSS 51. When the number of UE in the short-distance area is larger than a predetermined threshold, the message analysis unit 14 determines to deliver information using cell broadcast communication (S24). When, on the other hand, the number of UE in the short-distance area is smaller than a predetermined threshold, the message analysis unit 14 determines to deliver information using unicast communication (S25).

After Step S24 or Step S25, the delivery unit 16 extracts the delivery information corresponding to the delivery area from the information management unit 12 (S26). To be specific, the delivery unit 16 extracts the delivery information corresponding to the delivery area from the information management unit 12 by using the delivery area determined in Step S22 and the details of the event which the event notification message has given a notification about.

Then, the message analysis unit 14 determines whether there is an uncounted area where the number of UE in the area is not counted (S27). For example, the message analysis unit 14 determines whether there is an uncounted area where the number of UE is not counted among the short-distance area, the intermediate-distance area and the long-distance area. When the message analysis unit 14 determines that there is an uncounted area, it repeats the processing after Step S23 and counts the number of UE in the uncounted area. When, on the other hand, the message analysis unit 14 determines that there is no uncounted area, it sends the delivery message to the CBC 31 or the PGW 41 (S28).

As an information delivery means, cell broadcast communication and unicast communication may coexist. For example, information may be delivered using cell broadcast communication to the UE located in the short-distance area, and information may be delivered using unicast communication to the UE located in the intermediate-distance area and the long-distance area.

Further, when performing unicast communication, the delivery information may be changed depending on the terminal type of the UE, or the delivery information may be changed depending on the age of a user who has the UE and the subscriber information of the UE as described in the third exemplary embodiment.

As described above, with use of the message delivery process according to the fourth exemplary embodiment of the present invention, the delivery device 10 can select whether to use cell broadcast communication or unicast communication for each delivery area. Thus, when the number of UE in a delivery area is larger than a predetermined threshold, for example, it is possible to efficiently deliver information to the UE using cell broadcast communication. This prevents an increase in the load on the information delivery system that is caused by an increase in control messages sent and received in the information delivery system which occurs when performing unicast communication with a large number of UE.

When, on the other hand, the number of UE in a delivery area is smaller than a predetermined threshold, it is possible to deliver information to the UE using unicast communication. This enables delivery of different information for each UE, and it is thus possible to deliver information necessary for each UE.

### Fifth Exemplary Embodiment

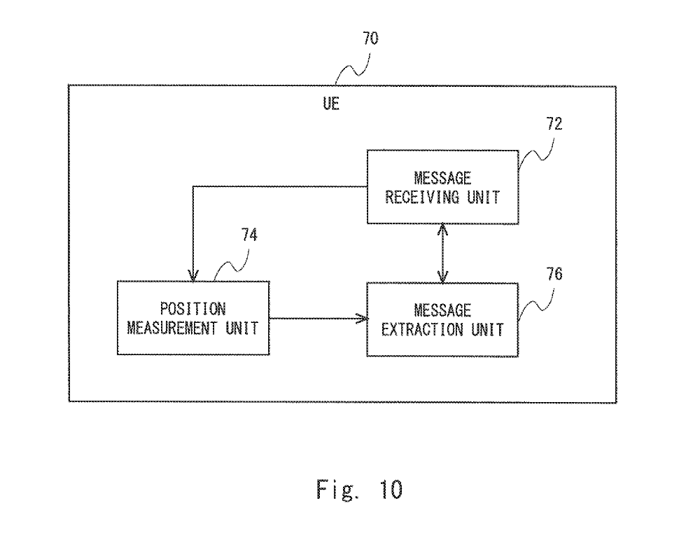

A configuration example of UE 70 according to a fifth exemplary embodiment of the present invention is described hereinafter with reference to FIG. 10. In the fifth exemplary embodiment, the delivery device 10 delivers the same information to the UE located in each of the short-distance area, the intermediate-distance area and the long-distance area. To be specific, the delivery device 10 delivers information that contains all of the content to be delivered to each of the short-distance area, the intermediate-distance area and the long-distance area to the UE. The configuration example of the UE that receives information containing all of the content to be delivered to each of the short-distance area, the intermediate-distance area and the long-distance area is described hereinbelow.

The UE 70 includes a message receiving unit 72, a position measurement unit 74 and a message extraction unit 76. The message receiving unit 72 receives the delivery information sent through the eNB. The delivery information contains, for example, all of information to be received by the UE located in each of the short-distance area, the intermediate-distance area and the long-distance area. Further, the delivery information contains information about the place where an event has occurred.

The position measurement unit 74 measures the distance between itself and the place where an event has occurred. When the position measurement unit 74 has a GPS function, for example, it may measure the distance between its position that is measured using the GPS and the place where an event has occurred that is contained in the delivery information. Alternatively, the position measurement unit 74 may measure the distance between itself and the place where an event has occurred by using a cell ID. For example, the position measurement unit 74 may store information indicating the positions of cells. The position measurement unit 74 may measure the distance between itself and the place where an event has occurred by using the cell ID of the cell where it is located, the cell ID of the place where an event has occurred contained in the delivery information, and information indicating the position of the cell.

The position measurement unit 74 measures the distance between itself and the place where an event has occurred and specifies in which of the short-distance area, the intermediate-distance area and the long-distance area centering on the place where an event has occurred it is located. For example, the position measurement unit 74 may set a threshold in advance, and determine that it is in the short-distance area when the measured distance is shorter than the threshold and determine that it is in the intermediate-distance area or the long-distance area when the measured distance is longer than the threshold. Further, the position measurement unit 74 may determine whether it is in the intermediate-distance area or the long-distance area by using a threshold different from above threshold.

The message extraction unit 76 extracts a message corresponding to the area where it is located from the delivery information.

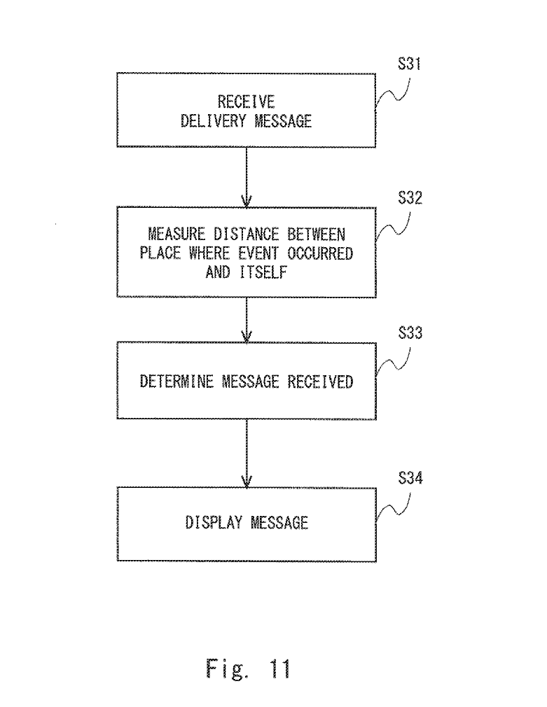

A flow of a delivery information receiving process in the UE 70 is described hereinafter with reference to FIG. 11. First, the message receiving unit 72 receives delivery messages delivered from the delivery device 10 (S31). Next, the position measurement unit 74 measures the distance between the place where an event has occurred and itself (S32). In this step, the position measurement unit 74 determines in which of the short-distance area, the intermediate-distance area and the long-distance area it is located by using the measurement result.

Then, the message extraction unit 76 extracts a message corresponding to its area from among the received delivery messages (S33). After that, the message extraction unit 76 outputs the extracted message to a display unit (not shown) or the like of the UE 70 to display the message.

As described above, the UE 70 according to the fifth exemplary embodiment of the present invention can measure the distance between the place where an event has occurred and itself. The UE 70 can thereby select and receive the message corresponding to the area in which it is located from among a plurality of information to be delivered to a plurality of areas. Accordingly, the delivery device 10 that delivers messages does not need to generate messages for the respective delivery areas and only needs to generate one message that contains all messages, and it is thus possible to reduce the load on the message generation process.

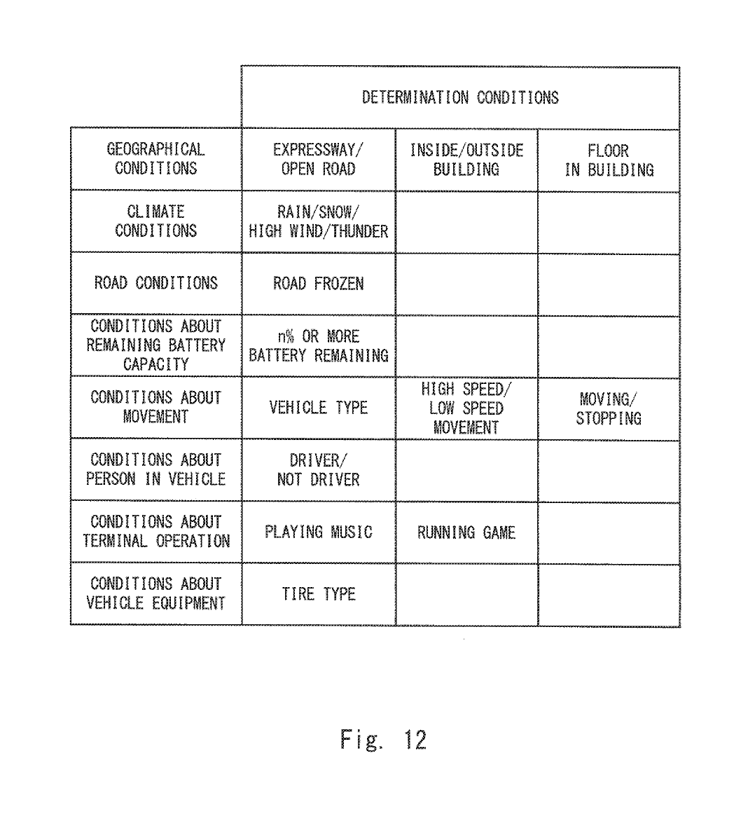

Although it is described above that the message extraction unit 76 makes a determination about which message should be extracted based on its position, it may make a determination about whether to extract a message or discard a message by using other determination conditions. Other determination conditions are described hereinafter with reference to FIG. 12.

For example, geographical conditions may be used as the determination condition. To be specific, a determination may be made on whether the UE is located on an expressway or on an open road as the geographical condition. For example, when the delivery information indicates the policy that only the UE on an expressway should receive a message, only the UE on an expressway receives the message and the other UE discard the message. Whether the UE is located inside or outside a building, what floor in a building it is located on and the like may be, for example, used as the determination condition.

When determining the geographical conditions, the UE may determine its position by using GPS information and map information. Alternatively, when the UE is a communication terminal mounted on a vehicle, the UE may determine its position in cooperation with a car navigation system, or may determine its position in cooperation with ETC, ITS spot, BICS information and the like. When the UE is a card terminal that is used as an employee card, the UE may determine what floor in a building it is currently located based on read information of the employee card.

The case where climate conditions are used as the determination conditions is described next. To be specific, a determination may be made based on rain, snow, high wind, thunder and the like as the climate conditions. For example, the delivery information may indicate the policy that only the UE in a rainy area should receive a message.

When determining the climate conditions, the UE may determine weather information of the area where it is located by using its position information and weather forecast information corresponding to that position. Alternatively, the UE may determine weather information based on image information taken using a camera. The UE may determine weather information by using weather information input by a user.

The case where road conditions are used as the determination conditions is described next. To be specific, a determination may be made based on whether a road is frozen or not as the road condition. For example, the delivery information may indicate the policy that only the vehicle traveling in an area where a road is frozen should receive a message. When determining the road conditions, the same method as that used when determining the climate conditions may be used. Further, when determining the road conditions, whether a road is frozen or not may be determined by using vehicle brake information.

The case where conditions about the remaining battery capacity are used as the determination conditions is described next. To be specific, a determination may be made on whether the remaining battery capacity is n % or more (n is a predetermined value) or not as the conditions about the remaining battery capacity. Besides, whether the UE is currently charged or not, the length of time that has passed since the last charge and the like may be determined.

The case where conditions about movement are used as the determination conditions is described next. To be specific, as the conditions about movement, vehicle types such as car, motor cycle, bicycle, train, taxi and bullet train as a user's transportation means may be used. Alternatively, as the conditions about movement, whether a user who has the UE is moving at a high speed or a low speed, or whether a user who has the UE is moving or stopping may be used. When determining the conditions about movement, a moving speed may be detected, and a vehicle type may be determined based on the moving speed. Further, whether it is moving or stopping may be determined by determining whether an engine is on or off. Further, the UE may determine whether an accident is happening or not based on accident information input by a user or the like. Further, the UE may determine whether a vehicle is stuck in traffic or not by using brake information of the vehicle, information about a moving speed or the like.

The case where conditions about a person in a vehicle are used as the determination conditions is described next. To be specific, as the conditions about a person in a vehicle, whether the UE is one used by a driver or one used by a person other than a driver may be used. Whether the UE is being used by a driver or not may be determined based on information input by a user who operates the UE.

The case where conditions about a terminal operation are used as the determination conditions is described next. To be specific, as the conditions about a terminal operation, whether the UE is playing music or running a game or the like may be determined. Whether the UE is playing music or running a game or the like may be determined in cooperation with application information or the like that is running the UE.

The case where conditions about vehicle equipment are used as the determination conditions is described next. To be specific, a tire type may be determined as the condition about vehicle equipment. As the tire type, whether a tire is a normal tire or a studless tire may be, for example, determined. The tire type may be determined based on information input by a user who operates the UE.

Besides, various determination conditions other than those illustrated in FIG. 12 may be used. For example, information that instructs to automonously send a vehicle number in order to search for a stolen vehicle may be delivered.

The delivery device 10 can add the determination conditions shown in FIG. 12 or determination conditions other than the determination conditions shown in FIG. 12 to the delivery information and send them to the UE.

### Sixth Exemplary Embodiment

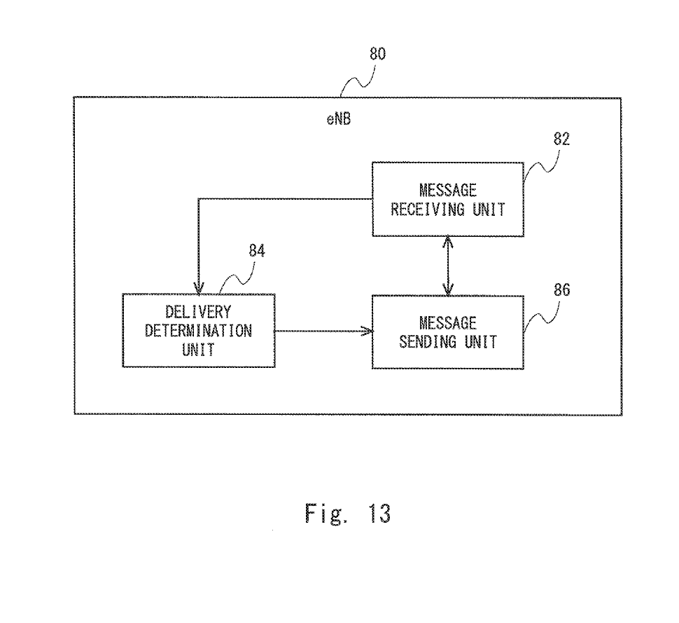

A configuration example of eNB according to a sixth exemplary embodiment of the present invention is described hereinafter with reference to FIG. 13. In the sixth exemplary embodiment, the delivery device 10 delivers the same information to eNB located in each of the short-distance area, the intermediate-distance area and the long-distance area. To be specific, the delivery device 10 delivers delivery information that contains all of the content to be delivered to each of the short-distance area, the intermediate-distance area and the long-distance area to all of the eNB located in each of the short-distance area, the intermediate-distance area and the long-distance area. The configuration example of the eNB in the case where all of the eNB receive the delivery information that contains all of the content to be delivered to each of the short-distance area, the intermediate-distance area and the long-distance area is described hereinbelow.

The delivery information contains a delivery destination cell ID list and information about association between a cell ID and a delivery message.

The eNB 80 includes a message receiving unit 82, a delivery determination unit 84, and a message sending unit 86. The message receiving unit 82 receives delivery information delivered from the MME 32. The message receiving unit 82 outputs the received delivery information to the delivery determination unit 84 and the message sending unit 86.

The delivery determination unit 84 determines whether the cell ID list of the delivery information output from the message receiving unit 82 contains the cell ID that identifies the cell formed by the eNB 80. When the delivery determination unit 84 determines that the cell ID list contains the cell ID that identifies the cell formed by the eNB 80, it extracts a delivery message associated with the cell formed by the eNB 80 from the delivery information. The delivery determination unit 84 then outputs the extracted delivery information to the message sending unit 86. The message sending unit 86 sends the delivery message output from the delivery determination unit 84 to the UE located in the cell formed by the delivery determination unit 84.

On the other hand, when the delivery determination unit 84 determines that the cell ID list does not contain the cell ID that identifies the cell formed by the eNB 80, it may discard the delivery information output from the message receiving unit 82.

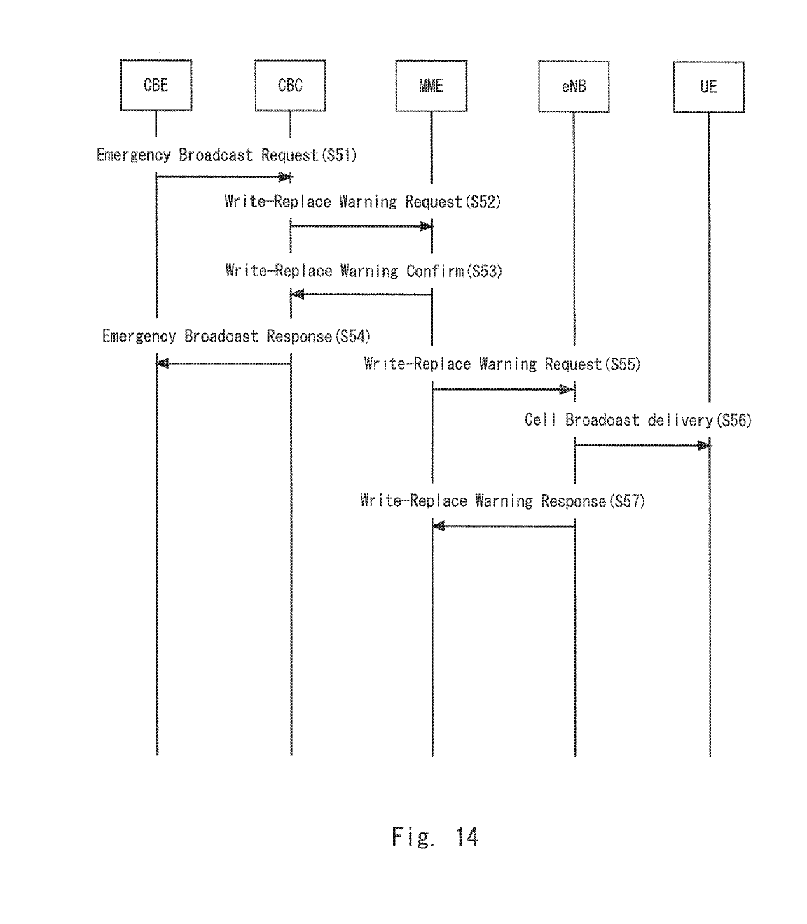

A flow of a process in the case of using a network specified by the 3GPP is specifically described with reference to FIG. 14. FIG. 14 is a diagram showing a flow of the process in the case of using E-UTRAN. The CBE in FIG. 14 is a device that requests broadcast delivery, and it may be, for example, the delivery device 10.

First, the CBE sends an Emergency Broadcast Request message to the CBC in order to request broadcast delivery (S51). Next, the CBC sends a Write-Replace Warning Request message to the MME (S52). The MME sends a Write-Replace Warning Confirm message to the CBX as a response to the Write-Replace Warning Request message (S53). Further, the CBC sends an Emergency Broadcast Response message as a response to the Emergency Broadcast Request message (S54).

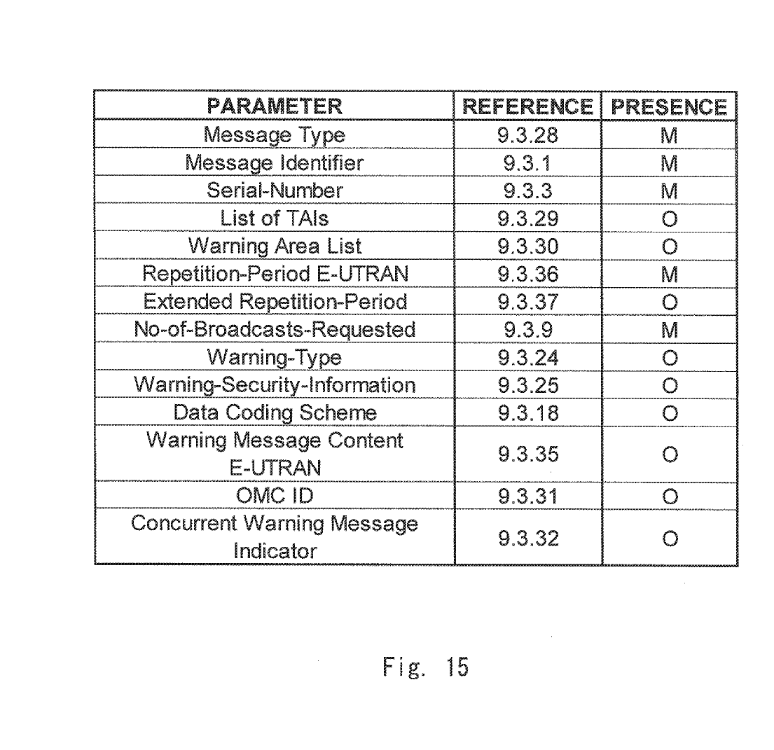

Then, the MME sends a Write-Replace Warning Request message sent from the CBC to the eNB (S55). The Write-Replace Warning Request message sent in Steps S52 and S55 is described in detail with reference to FIG. 15.

FIG. 15 shows a list of parameters set to the Write-Replace Warning Request message. REFERENCE indicates a place that is referred to in TS23.401 (V12.2.0), which is the technical specification of the 3GPP. PRESENCE indicates whether each parameter is a mandatory parameter (M) which is always set or an optional parameter (O) which is arbitrarily set.

The delivery information is set to Warning Message Content E-UTRAN shown in FIG. 15. This delivery information is, for example, the delivery information that contains all of the content to be delivered to each of the short-distance area, the intermediate-distance area and the long-distance area as described above. For example, the content to be delivered to each of the short-distance area, the intermediate-distance area and the long-distance area is set by dividing the setting area of Warning Message Content E-UTRAN.

Further, a delivery destination cell ID and a place in which a message to be delivered in each cell ID is stored are set to the Warning Area List shown in FIG. 15. For example, in the Warning Area List, information indicating delivery of the message set to X byte to Y byte (X and Y are 0 or given natural numbers) of Warning Message Content E-UTRAN to the UE for the cell ID 1 to 10 (when the cell ID is identified by numbers) is set.

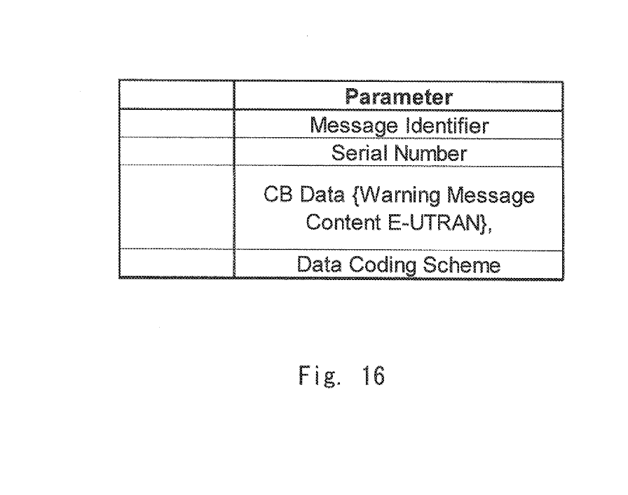

Referring back to FIG. 14, the eNB receives the Write-Replace Warning Request message and determines whether the Warning Area List contains the cell ID about the cell formed by itself. When the cell ID about the cell formed by itself is contained, the eNB sends a Cell Broadcast delivery message to the UE in order to send the message set to the Warning Message Content E-UTRAN, which is the message at the place indicated by the Warning Area List, to the UE (S56). For example, as shown in FIG. 16, the eNB sets a message selected among the messages set to the Warning Message Content E-UTRAN to CB Data, which is a parameter in the Cell Broadcast delivery message. Referring back to FIG. 14, after sending the Cell Broadcast delivery message, the eNB sends a Write-Replace Warning Response message to the MME (S57).

Other examples of the structures of parameters illustrated in FIG. 15 are described hereinafter. For example, a plurality of Warning Message Content E-UTRAN such as Warning Message Content E-UTRAN (1), Warning Message Content E-UTRAN (2) and Warning Message Content E-UTRAN (3) may be defined, and the content to be delivered to the short-distance area may be set to Warning Message Content E-UTRAN (1), the content to be delivered to the intermediate-distance area may be set to Warning Message Content E-UTRAN (2), and the content to be delivered to the long-distance area may be set to Warning Message Content E-UTRAN (3). Further, a plurality of Warning Area List such as Warning Area List (1), Warning Area List (2) and Warning Area List (3) may be defined, the cell ID included in the short-distance area may be set to Warning Area List (1), the cell ID included in the intermediate-distance area may be set to Warning Area List (2), and the cell ID included in the long-distance area may be set to Warning Area List (3).

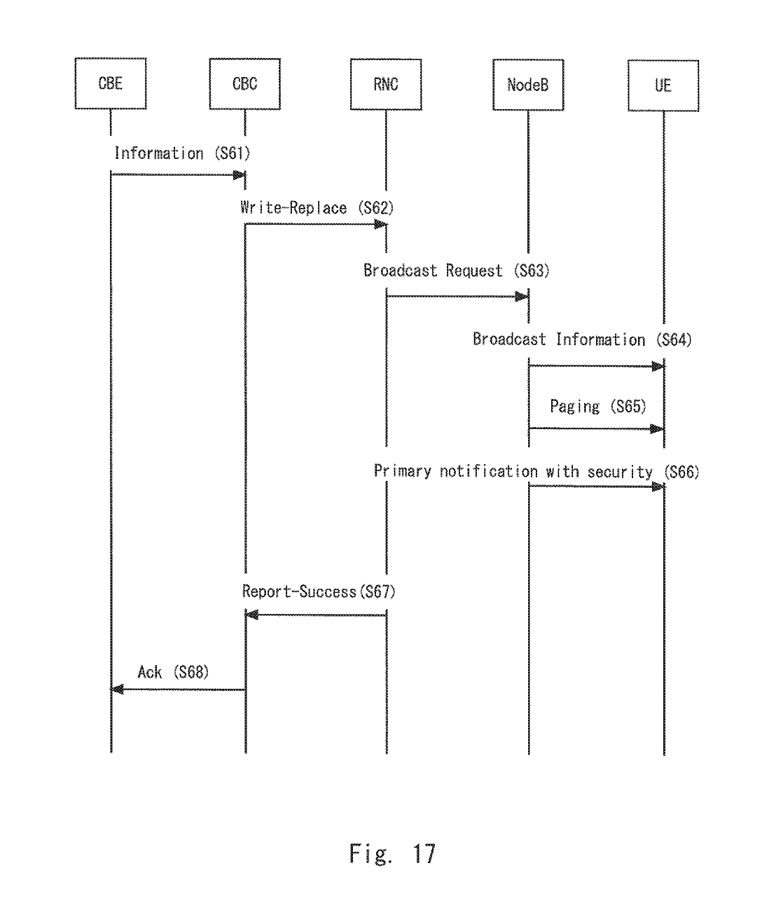

A flow of a process in the case of using another network specified by the 3GPP is specifically described with reference to FIG. 17. FIG. 17 is a diagram showing a flow of the process in the case of using UMTS. NodeB is a base station that is used in the UMTS. RNC (Radio Network Controller) is a device that puts together the NodeB.

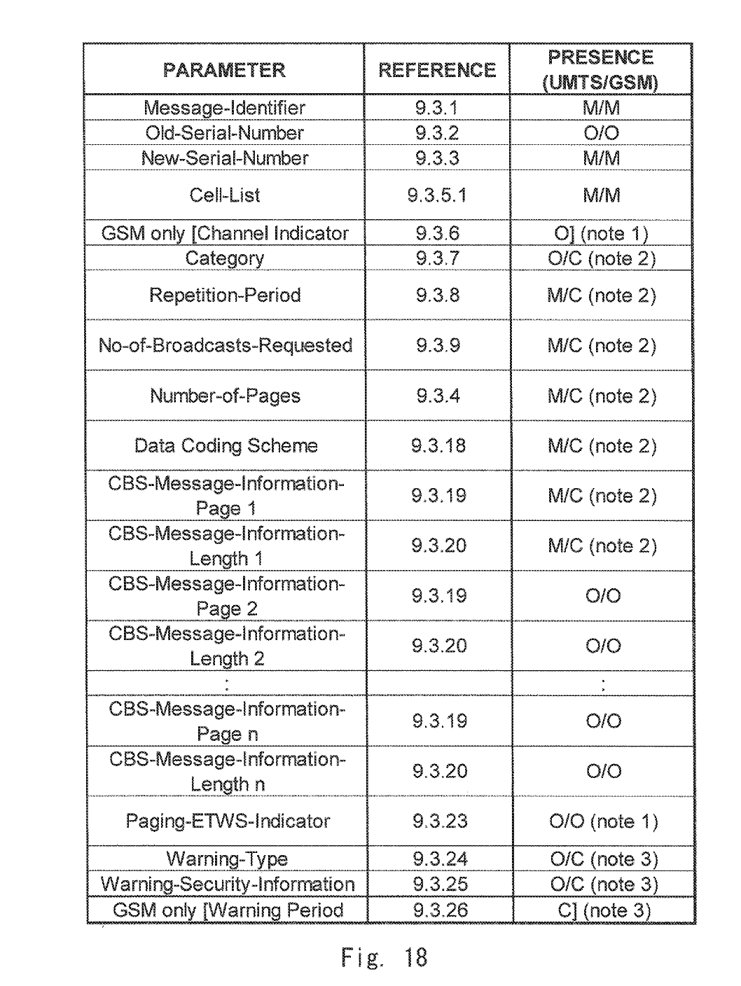

First, the CBE sends an Information message to the CBC in order to request broadcast delivery (S61). Next, the CBC sends a Write-Replace message to the RNC (S62). The Write-Replace message sent in Step S62 is described in detail with reference to FIG. 18.

FIG. 18 shows a list of parameters set to the Write-Replace message. REFERENCE indicates a place that is referred to in TS23.401 (V12.2.0), which is the technical specification of the 3GPP. PRESENCE indicates whether each parameter is a mandatory parameter (M) which is always set or an optional parameter (O) which is arbitrarily set.

The delivery information is set to CBS-Message-Information-Page 1 to n shown in FIG. 18. This delivery information is, for example, the delivery information that contains all of the content to be delivered to each of the short-distance area, the intermediate-distance area and the long-distance area as described above. For example, the content to be delivered to the short-distance area may be set to CBS-Message-Information-Page 1, the content to be delivered to the short-distance area may be set to CBS-Message-Information-Page 2, and the content to be delivered to the short-distance area may be set to CBS-Message-Information-Page 3.

Further, a delivery destination cell ID and a place in which a message to be delivered in each cell ID is stored are set to the Cell-List shown in FIG. 18. For example, in the Cell-List, information indicating delivery of the message set to CBS-Message-Information-Page 1 to the UE for the cell ID 1 to 10 (when the cell ID is identified by numbers) is set.

Referring back to FIG. 17, the RNC receives the Write-Replace message and then sends a Broadcast Request message to the NodeB (S63). When the RNC receives the Write-Replace message, it determines whether the Cell-List contains the cell ID about the cell formed by the NodeB under control of itself. When the cell ID about the cell formed by the NodeB under control of itself is contained, the RNC sends the Broadcast Request message to the NodeB in order to send CBS-Message-Information-Page n indicated by the Cell-List to the UE.

Then, the NodeB that has received the Broadcast Request message sends a Broadcast Information message (S64), a Paging message (S65) and a Primary notification with security message (S66) to the UE. Further, after sending the Broadcast Request in Step S63, the RNC sends a Report-Success message to the CBC (S67). The CBC receives the Report-Success message and then sends an Ack message to the CBE (S68).

Other examples of the structures of parameters illustrated in FIG. 18 are described hereinafter. For example, the setting area of CBS-Message-Information-Page 1 may be divided, and the content to be delivered to the short-distance area, the content to be delivered to the intermediate-distance area, and the content to be delivered to the long-distance area may be set. Further, a plurality of Cell-List such as Cell-List (1), Cell-List (2) and Cell-List (3) may be defined, the cell ID included in the short-distance area may be set to Cell-List (1), the cell ID included in the intermediate-distance area may be set to Cell-List (2), and the cell ID included in the long-distance area may be set to Cell-List (3).

Further, in the sixth exemplary embodiment, the case where the delivery device 10 delivers delivery information that contains all of the content to be delivered to each of the short-distance area, the intermediate-distance area and the long-distance area to all of the eNB or the RNC located in the short-distance area, the intermediate-distance area and the long-distance area is described. Therefore, a parameter indicating that all of the content to be delivered to each of the short-distance area, the intermediate-distance area and the long-distance area are contained in the delivery information may be added to the list of parameters shown in FIG. 15 and FIG. 18. When the added parameter indicates that all of the content to be delivered to each of the short-distance area, the intermediate-distance area and the long-distance area are contained in the delivery information, the operation according to the sixth exemplary embodiment of the present invention is performed, and when the added parameter does not indicate that all of the content to be delivered to each of the short-distance area, the intermediate-distance area and the long-distance area are contained in the delivery information, the operation described in the second exemplary embodiment or the like may be performed.

### Seventh Exemplary Embodiment

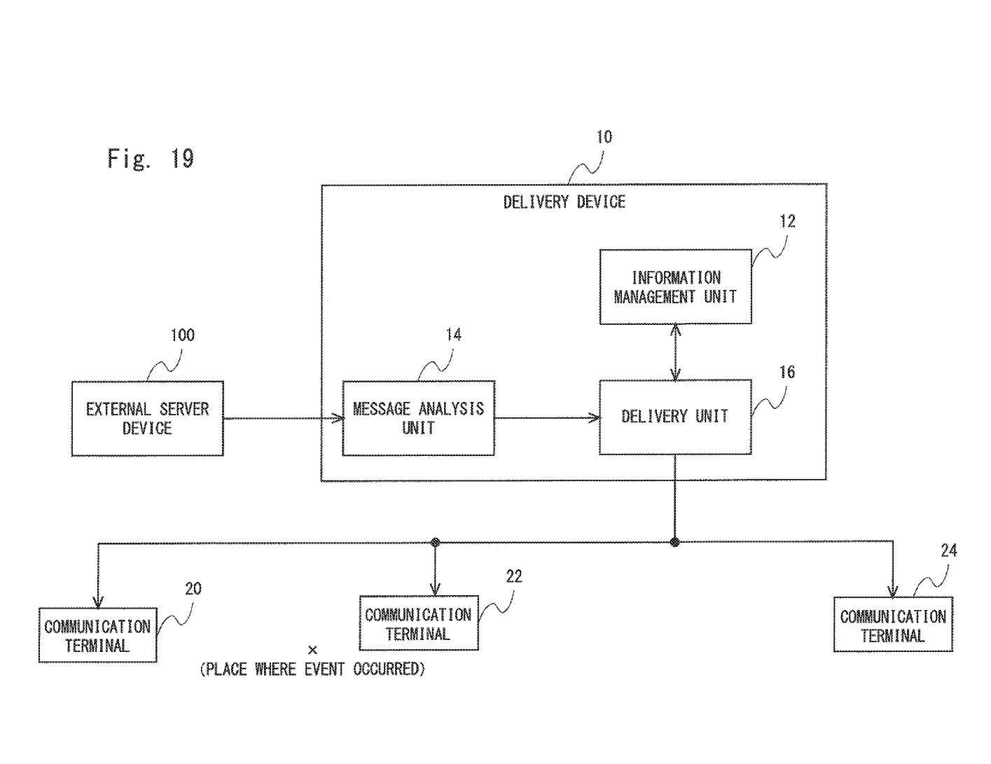

A configuration example of an information delivery system according to a seventh exemplary embodiment of the present invention is described hereinafter with reference to FIG. 19. Although the configuration where the delivery device 10 acquires the event notification message from the communication terminal 22 is illustrated in FIG. 1, the configuration where the delivery device 10 acquires the event notification message from an external server device 100, not from the communication terminal 22, is illustrated in FIG. 19. For example, the message analysis unit 14 of the delivery device 10 may receive the event notification message that is sent from the external server device 100 that has detected an event. Further, the external server device 100 may detect an event by collecting the event notification message from the communication terminal 22 or the like, or may detect an event by another means. Further, the delivery device 10 may acquire the event notification message from the communication terminal 22 in addition to acquiring the event notification message from the external server device 100.

As another means, when the external server device 100 is a server that forms a traffic control system having a plurality of sensor devices on roads, for example, the external server device 100 may detect an event by collecting information detected by the plurality of sensor devices.

As described above, with use of the information delivery system according to the seventh exemplary embodiment of the present invention, the message analysis unit 14 can acquire the event notification message by another means such as the external server device, not only from the communication terminal 22.

### Eighth Exemplary Embodiment

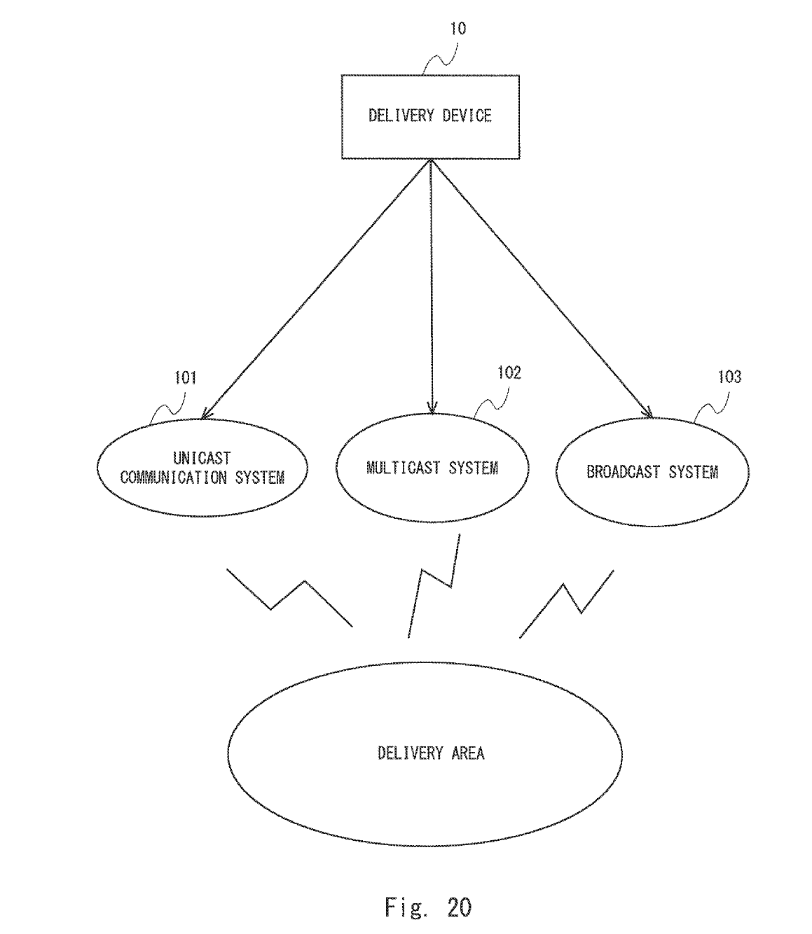

A configuration example of an information delivery system according to an eighth exemplary embodiment of the present invention is described hereinafter with reference to FIG. 20. The delivery device 10 in this figure delivers information to delivery areas through a unicast communication system 101, a multicast system 102, and a broadcast system 103.

The unicast communication system 101 may be, for example, SMS. The multicast system 102 may be, for example, IP multicast, MBMS or the like. The broadcast system 103 may be, for example, ETWS, CBS or the like. Further, the delivery device 10 is not limited to be connected to the unicast communication system 101, the multicast system 102 and the broadcast system 103, and a digital broadcasting system including 1-Seg broadcasting or the like, a radio broadcasting system, VICS (registered trademark) (Vehicle Information and Communication System) and the like may be used.

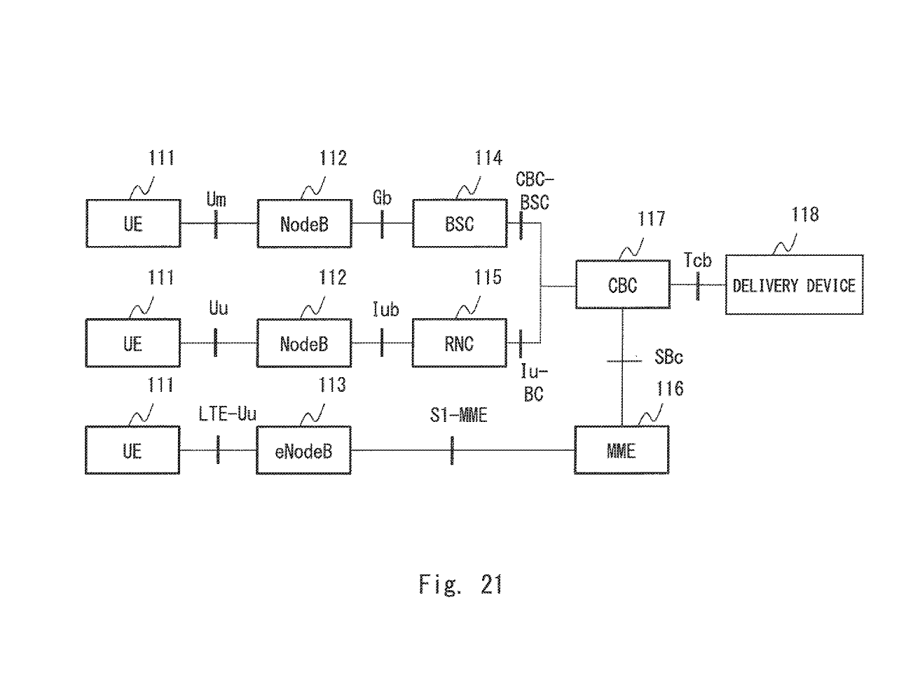

A specific network configuration in the case where the CBS is used as the broadcast system 103 is described hereinafter with reference to FIG. 21.

The network of FIG. 21 includes UE (User Equipment) 111, NodeB 112, eNodeB 113, BSC (Base Station Controller) 114, RNC (Radio Network Controller) 115, MME (Mobility Management Entity) 116, CBC (Cell Broadcast Center) 117, and a delivery device 118.

The UE 111 is a mobile communication device. The NodeB 112 and the eNodeB 113 are base station devices. Particularly, the eNodeB 113 is a base station device that is used in the LTE. The MME 16 mainly manages movement of the UE 111. The BSC 114 and the RNC 115 are devices that control the NodeB 112. The CBC 117 is a device that is used for cell broadcast. The delivery device 118 sends delivery information to the CBC 117.

Further, Um, Uu, LTE-Uu, Gb, Iub, CBC-BSC, Iu-BC, S1-MME, SBc and Tcb shown in FIG. 21 indicate interface names between the devices.

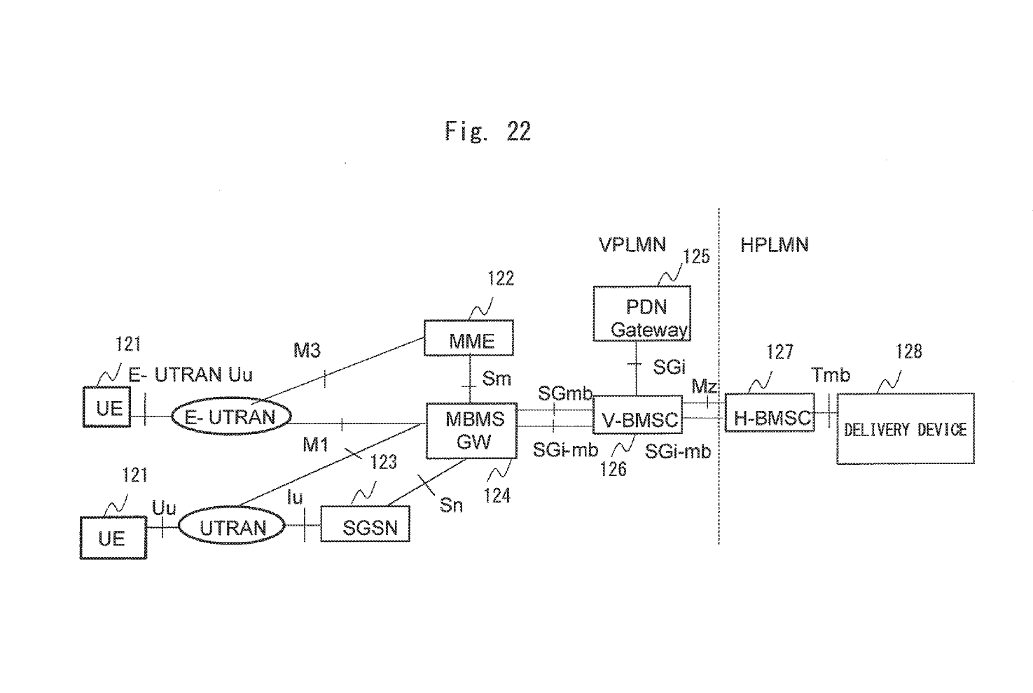

A specific network configuration in the case where the MBMS is used as the multicast system 102 is described hereinafter with reference to FIG. 22. The network of FIG. 22 includes UE 121, MME 122, SGSN 123, MBMS-GW 124, PDN-GW 125, V-BMSC (Broadcast Multicast Service Center) 126, H-BMSC 127, and a delivery device 128. The MBMS-GW 124 sends data to the UE through E-UTRAN and UTRAN. Further, since the network that includes the UE 121, the MME 122, the SGSN 123, the MBMS-GW 124, the PDN-GW 125, the V-BMSC 126 and the H-BMSC 127 is already known as the network that is specified by the 3GPP, detailed description thereof is omitted.

The delivery device 128 sends delivery information to the H-BMSC 127. The BMSC is a device that stores the content transmitted by the MBMS. Further, the MBMS-GW 124 sends the delivery information sent through the H-BMSC 127 and the V-BMSC 126 by using IP multicast.

Further, E-UTRAN Uu, Uu, M3, M1, Iu, Sm, Sn, SGmb, SGi-mb, SGi, SGi-mb, Mz and Tmb shown in FIG. 22 indicate interface names between the devices.

As described above, with use of the information delivery system according to the eighth exemplary embodiment of the present invention, the delivery device can be connected with a system using different delivery means.

Although the present invention is described as a hardware configuration in the above exemplary embodiments, the present invention is not limited thereto. The present invention may be implemented by causing a CPU (Central Processing Unit) to execute a computer program to perform the processing of the delivery device or the communication terminal.

The above-described program can be stored and provided to the computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

It should be noted that the present invention is not restricted to the above-described exemplary embodiment, and various changes and modifications may be made without departing from the scope of the invention. For example, the functions achieved by the delivery devices 10, 118 and 128 may be implemented in the CBC 31. Alternatively, the functions achieved by the delivery devices 10, 118 and 128 may be implemented in MTC-IWF, SCS or the like specified by the 3GPP. Alternatively, the functions achieved by the delivery devices 10, 118 and 128 may be implemented in a service platform managed by a service provider or a server device managed by a service provider. Alternatively, the functions achieved by the delivery devices 10, 118 and 128 may be implemented in a node device managed by a communication common carrier.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2013-140157, filed on Jul. 3, 2013, the disclosure of which is incorporated herein in its entirety by reference.

### REFERENCE SIGNS LIST

10 DELIVERY DEVICE
12 INFORMATION MANAGEMENT UNIT
14 MESSAGE ANALYSIS UNIT
16 DELIVERY UNIT
20 COMMUNICATION TERMINAL
22 COMMUNICATION TERMINAL
24 COMMUNICATION TERMINAL
31 CBC
32 MME
33 eNB
34 eNB
35 eNB
36 UE
37 UE
38 UE
41 PGW
42 SGW
51 HSS
61 eNB
62 eNB
63 eNB
64 eNB
65 UE
66 UE
67 UE
68 UE
70 UE
72 MESSAGE RECEIVING UNIT
74 POSITION MEASUREMENT UNIT
76 MESSAGE EXTRACTION UNIT
80 eNB
82 MESSAGE RECEIVING UNIT
84 DELIVERY DETERMINATION UNIT
86 MESSAGE SENDING UNIT
100 EXTERNAL SERVER DEVICE
101 UNICAST COMMUNICATION SYSTEM
102 MULTICAST SYSTEM
103 BROADCAST SYSTEM
111 UE
112 NodeB
113 eNodeB
114 BSC
115 RNC
116 MME
117 CBC
118 DELIVERY DEVICE
121 UE
122 MME
123 SGSN
124 MBMS-GW
125 PDN-GW
126 V-BMSC
127 H-BMSC
128 DELIVERY DEVICE

1. A delivery device comprising:
an information management unit that manages delivery information to be delivered to a plurality of communication terminals located in a peripheral area including a place where an event has occurred, the delivery information being determined depending on details of the event and a distance from the place where the event has occurred;
a message analysis unit that, when an event notification message indicating occurrence of an event is sent, analyzes the place where the event has occurred and details of the event by using the event notification message; and
a delivery unit that extracts delivery information managed in the information management unit based on an analysis result in the message analysis unit, and delivers the extracted delivery information to the plurality of communication terminals located in the peripheral area.

2. The delivery device according to claim 1, wherein the information management unit includes:
an area management table that manages the place where the event has occurred and a delivery area where delivery information is to be delivered in association with each other; and
an information management table that manages the delivery area and the delivery information in association with each other.

3. The delivery device according to claim 2, wherein the area management table manages a plurality of delivery areas depending on a distance from the place where the event has occurred.

4. The delivery device according to claim 2, wherein the information management table manages each of the delivery areas in association with different delivery information.

5. The delivery device according to claim 4, wherein the delivery unit delivers, to the communication terminal, different delivery information for each of the delivery areas.

6. The delivery device according to claim 4, wherein the delivery unit generates one message containing a plurality of delivery information managed in the information management table and delivers the message to a plurality of delivery areas.

7. The delivery device according to claim 1, wherein the delivery unit changes behavior of the communication terminal to receive the delivery information depending on a distance from the place where the event has occurred.

8. The delivery device according to claim 1, wherein the delivery unit changes priority of delivering the delivery information depending on a distance from the place where the event has occurred.

9. The delivery device according to claim 1, wherein the delivery unit delivers the delivery information by using at least one of unicast communication and broadcast delivery.

10. The delivery device according to claim 9, wherein the delivery unit selects either one of the unicast communication and the broadcast delivery based on the number of communication terminals located in the peripheral area, and delivers the delivery information by using the selected communication unit.

11. A communication terminal comprising:
a receiving unit that receives delivery information delivered from a delivery device that delivers delivery information to be delivered to a plurality of communication terminals located in a peripheral area including a place where an event has occurred, the delivery information being determined depending on details of the event and a distance from the place where the event has occurred;
a distance measurement unit that measures a distance between a position of the communication terminal and the place where the event has occurred; and
an information extraction unit that extracts information to be received from the delivery information based on a measurement result in the distance measurement unit.

12. The communication terminal according to claim 11, wherein the distance measurement unit measures a distance from the place where the event has occurred by using a GPS function or a cell ID identifying a cell where the communication terminal is located.

13. A delivery method comprising:
receiving an event notification message indicating occurrence of an event;
analyzing a place where the event has occurred and details of the event by using the event notification message;
extracting delivery information from an information management unit that manages delivery information to be delivered to a plurality of communication terminals located in a peripheral area including a place where an event has occurred, the delivery information being determined depending on details of the event and a distance from the place where the event has occurred based on a result of the analysis; and
delivering the extracted delivery information to the plurality of communication terminals located in the peripheral area.

14. A receiving method comprising:
receiving delivery information delivered from a delivery device that delivers delivery information to be delivered to a plurality of communication terminals located in a peripheral area including a place where an event has occurred, the delivery information being determined depending on details of the event and a distance from the place where the event has occurred;
measuring a distance between a position of a communication terminal and the place where the event has occurred; and
extracting information to be received from the delivery information based on a result of the measurement.

15. A non-transitory computer readable medium storing a program causing a computer to execute:
a step of receiving an event notification message indicating occurrence of an event;
a step of analyzing a place where the event has occurred and details of the event by using the event notification message;
a step of extracting delivery information from an information management unit that manages delivery information to be delivered to a plurality of communication terminals located in a peripheral area including a place where an event has occurred, the delivery information being determined depending on details of the event and a distance from the place where the event has occurred based on a result of the analysis; and
a step of delivering the extracted delivery information to the plurality of communication terminals located in the peripheral area.

16. A non-transitory computer readable medium storing a program causing a computer to execute:
a step of receiving delivery information delivered from a delivery device that delivers delivery information to be delivered to a plurality of communication terminals located in a peripheral area including a place where an event has occurred, the delivery information being determined depending on details of the event and a distance from the place where the event has occurred;
a step of measuring a distance between a position of a communication terminal and the place where the event has occurred; and
a step of extracting information to be received from the delivery information based on a result of the measurement.

17. A delivery device comprising:
a delivery unit that delivers information about an event to a communication device located in a specific area, wherein
the information differs depending on a positional relationship between a place where the event has occurred and the specific area.
